(19) United States
(12) Patent Application Publication
(10) Pub. No.: US 2022/0016452 A1
(43) Pub. Date: Jan. 20, 2022

(54) FACE MASK WITH CENTRAL FLAP

(71) Applicant: Phillip W. Weiss, New York, NY (US)

(72) Inventor: Phillip W. Weiss, New York, NY (US)

(21) Appl. No.: 17/248,091

(22) Filed: Jan. 8, 2021

Related U.S. Application Data
(60) Provisional application No. 62/705,740, filed on Jul. 14, 2020.

(51) Int. Cl. A62B 18/08; A41D 13/11; A62B 18/02; A62B 7/10; A62B 23/02

(52) U.S. Cl. CPC A62B 18/086; A41D 13/1107; A62B 18/025; A41D 13/1161; A62B 23/02; A62B 18/084; A41D 2300/322; A62B 7/10

(57) ABSTRACT

A resealable, openable face mask includes a mask body with a central flap. The central flap is filter air when closed and provides access to a user's mouth when open. The mask body has a loop on a left edge; a loop on a right edge; a central aperture; the flap extending continuously from the mask body below the central aperture; and a zipper to close the flap over the central aperture.

### CROSS-REFERENCE TO RELATED APPLICATION

This application claims the benefit of priority of U.S. provisional application No. 62/705,740, filed Jul. 14, 2020, the contents of which are herein incorporated by reference.

### BACKGROUND OF THE INVENTION

The present invention relates to face masks and, more particularly, to a face mask that provides access to the mouth.

We are in a new age—the age of the face mask. Wearing a face mask will be a norm. Face masks are generally designed such that the mask must be removed before eating or drinking, which may leave the user less protected.

Some existing face masks have cumbersome flaps to allow ingestion of liquids but not food. Some masks have double-flapped operation which provides insufficient space to allow ingestion of food. In any case, the existing openable face masks do not provide a tight seal between the flap and the face mask body.

As can be seen, there is a need for a face mask that enables eating without removing the mask.

The present invention provides a face mask that allows ingestion of food without having to remove the mask. The inventive mask may have a single central flap that opens downward and may be resealed with a lightweight, flexible, plastic zipper. When a person wants to eat food, the inventive facemask makes the mouth accessible and allows the person to avoid removing the mask or pulling the mask down off the face. The person may merely open the flap and eat. The inventive face mask may become a welcome addition to one's wardrobe.

### SUMMARY OF THE INVENTION

In one aspect of the present invention, a resealable face mask is provided, comprising a mask body with a central flap extending therefrom, wherein the central flap is operative to filter air when in a closed position and is operative to provide access to a user's mouth when in an open position.

In another aspect of the present invention, an openable face mask is provided, comprising a mask body having a loop on a left edge; a loop on a right edge; a central aperture; a flap extending continuously from the mask body below the central aperture; and a zipper operative to retain the flap over the central aperture in a closed position.

These and other features, aspects and advantages of the present invention will become better understood with reference to the following drawings, description, and claims.

### BRIEF DESCRIPTION OF THE DRAWINGS

FIG. 1 is a perspective view of a face mask according to an embodiment of the present invention;

FIG. 2 is a front elevation view thereof, laid flat;

FIG. 3 is a front elevation view thereof, shown in use in a closed position;

FIG. 4 is another front elevation view thereof, shown in use in an open position;

FIG. 5 is a sectional view thereof, taken along line 5-5 in FIG. 1;

FIG. 6 is another sectional view thereof, taken along line 5-5 in FIG. 1, shown in an open position;

FIG. 7 is a perspective view of another embodiment of the present invention; and

FIG. 8 is a front view thereof, shown in use in a closed position.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As used herein, directional terms such as upper, lower, upward, downwardly, top, left, right and the like are used in relation to the illustrative embodiments as they are depicted in the figures, such that the upward direction (or upper) being toward the top of the corresponding figures and the downward direction being toward the bottom of the corresponding figures.

Broadly, one embodiment of the present invention is a resealable, openable face mask with a central zippered flap. The zipper openably reseals the mask. A user may open the central zippered flap, revealing a central aperture, to permit ingestion of food without having to pull down or remove the mask and may then close the flap to restore the protection provided by the mask.

The flap may have a semicircular or semioval shape and may be connected to the body of the mask at a crease line operable to urge the flap to fall outward. In some embodiments, a small loop may be provided on an outward-facing surface of the flap. The loop allows the user to pull the flap open.

While not intending to be limiting, the mask and flap may be manufactured of fabric operative to filter air. The inventive mask is not intended to be a surgical mask. Rather, it is a covering designed to contain the spread of droplets from the nose and mouth, not for use in a clinical setting. Accordingly, the mask may comprise one layer of a lightweight fabric with a flexible zipper installed in the middle thereof that may bend and fold to open and close the flap. In some cases, the fabric may be nonporous. It may be manufactured in a variety of colors and sizes.

A zipper may open and close the flap at the center of the mask. The zipper is preferably manufactured of a lightweight, flexible plastic.

In an embodiment, the zipper comprises a slider and a pair of tracks. The slider may easily slide along the tracks, ensuring an airtight seal. The zipper may be attached to the mask such that one track traverses the periphery of the flap and a second track traverses the periphery of the aperture around the mouth.

The inventive mask generally enables the wearer of the face mask to avoid the inconvenience of having to remove and then put on the face mask. It may make the facemask wearing experience less onerous and less uncomfortable.

The inventive mask may be worn in a manner consistent with a commercially available mask, except that the user may unzip the flap, ingest food and/or liquid, and reclose the flap with the zipper.

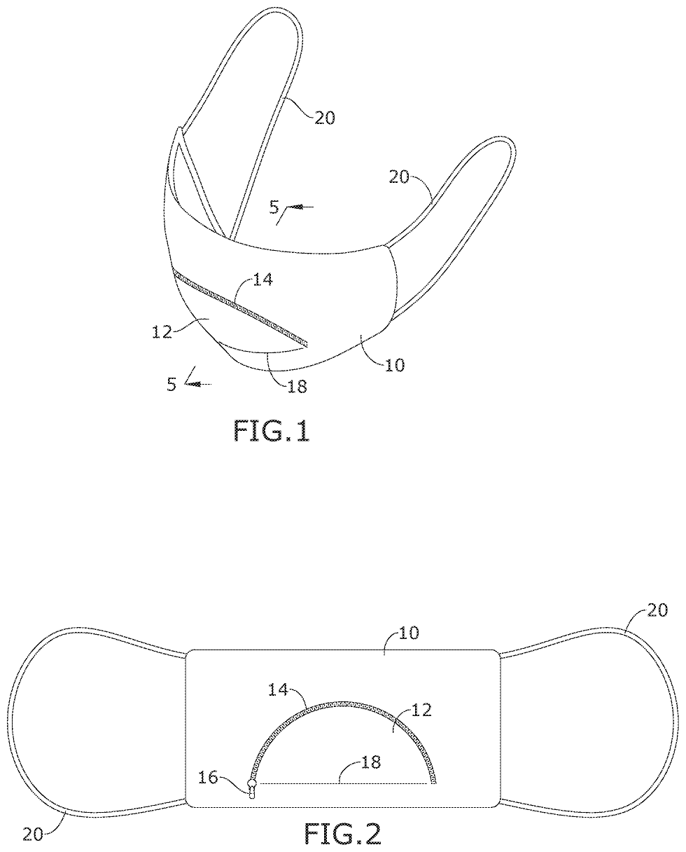

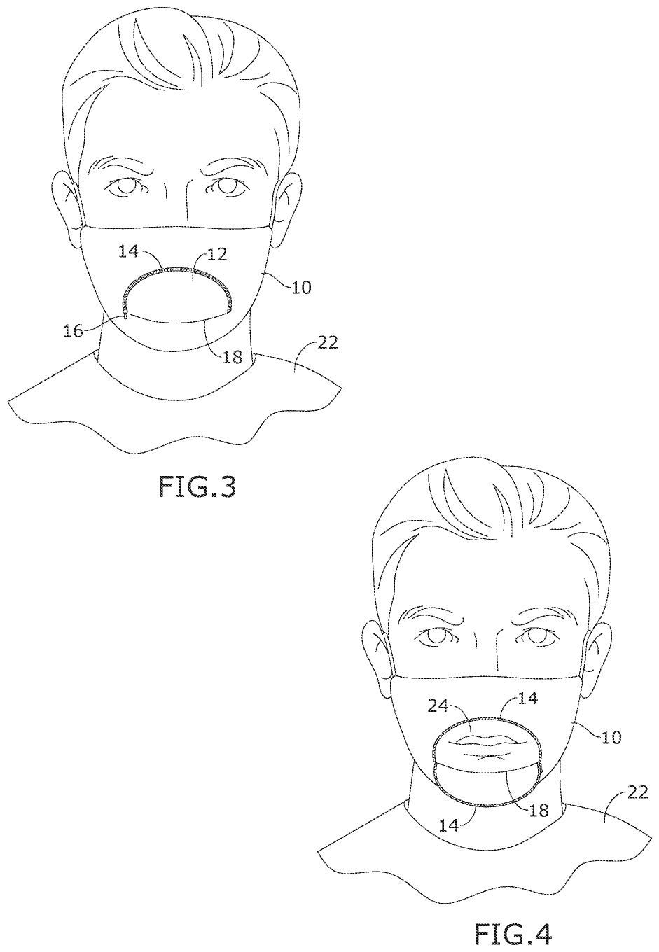

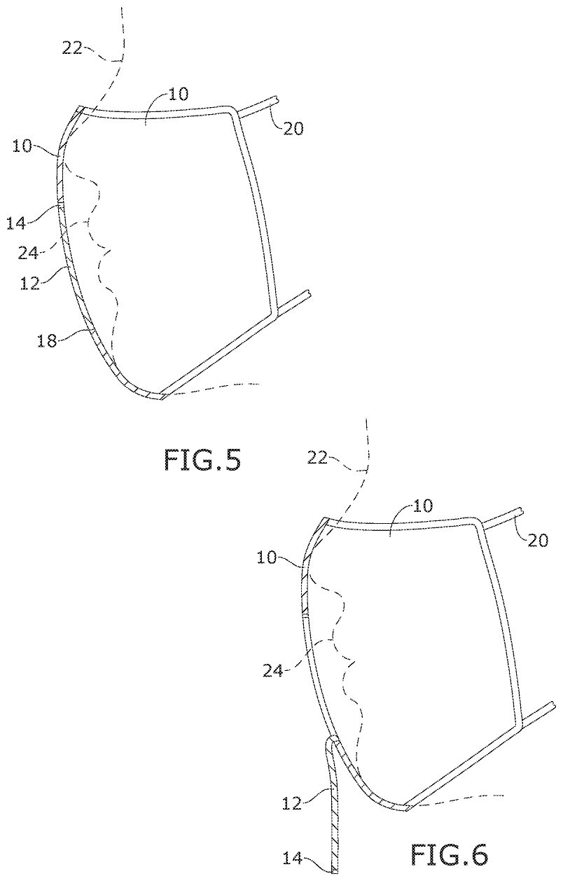

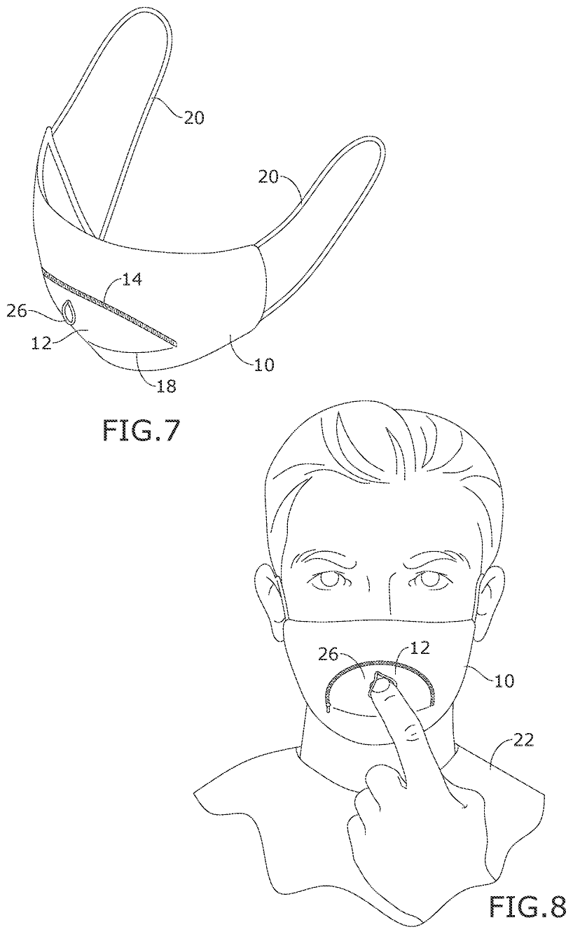

Referring to FIGS. 1 through 8, FIG. 1 show a facemask body 10 according to an embodiment of the present invention, with a flap 12 approximately semicircular in shape extending from the body 10 at a fold or crease line 18. The flap 12 has a zipper 14 with a pull 16 to seal the flap 12 to the body 10. The facemask body 10 has two ear loops 20 extending from the left and right edges operable to hold the mask on a user's 22 face, as shown in FIGS. 3 through 6 and 8. The user 22 may reveal the user's mouth 24, as shown in FIGS. 4 and 6, by unzipping the zipper 14 and allowing the flap 12 to fall open at the fold line 18. FIGS. 7 and 8 show another embodiment of the inventive facemask, with a pull loop 26 extending about centrally from the exterior of the flap 12 to assist the user 22 in opening the flap 12.

It should be understood, of course, that the foregoing relates to exemplary embodiments of the invention and that modifications may be made without departing from the spirit and scope of the invention as set forth in the following claims.

What is claimed is:

1. A resealable face mask, comprising a mask body with a central flap extending therefrom, wherein the central flap is operative to filter air when in a closed position and is operative to provide access to a user's mouth when in an open position.

2. The resealable face mask of claim 1, wherein the central flap is characterized by a semicircular to semioval shape.

3. The resealable face mask of claim 1, wherein the central flap extends from the mask body at a crease line operable to urge the central flap to fall away from a user's mouth.

4. The resealable face mask of claim 1, wherein the central flap further comprises a pull loop on a first surface opposite a second surface that is adjacent to a user's mouth when the central flap is in a closed position.

5. The resealable face mask of claim 1, further comprising an ear loop on opposing edges of the mask body.

6. The resealable face mask of claim 1, further comprising a zipper extending along a periphery of the central flap and of a central aperture in the mask body.

7. The resealable face mask of claim 6, wherein the zipper comprises a slider, a first track extending along the periphery of the central flap and a second track extending along the periphery of the central aperture, wherein the slider is slidably mounted on the first track and the second track.

8. An openable face mask, comprising a mask body having:
a. a loop on a left edge;
b. a loop on a right edge;
c. a central aperture;
d. a flap extending continuously from the mask body below the central aperture; and
e. a zipper operative to retain the flap over the central aperture in a closed position.

9. The openable face mask of claim 8, wherein the flap further comprises a pull loop on a surface facing away from a user's mouth in a closed position.

10. The openable face mask of claim 8, wherein the flap meets the mask body at a crease line.
